(19) United States
(12) Patent Application Publication
(10) Pub. No.: US 2004/0046973 A1
(43) Pub. Date: Mar. 11, 2004

(54) Printing apparatus and control program therefor

(75) Inventors: Yoshinori Sugahara, Kyoto-shi (JP); Yoshio Komaki, Kobe-shi (JP); Tetsuya Sugimoto, Muko-shi (JP); Yukinori Matsumoto, Amagasaki-shi (JP); Koichi Matsuo, Daito-shi (JP); Toshihiro Maeda, Sakai-shi (JP); Atsushi Ito, Yawata-shi (JP)

Correspondence Address: Barry E. Bretschneider, Morrison & Foerster LLP, Suite 300, 1650 Tysons Boulevard, McLean, VA, 22102, US

(73) Assignee: Minolta Co., Ltd., Osaka-shi (JP)

(21) Appl. No.: 10/653,231

(22) Filed: Sep. 3, 2003

(30) Foreign Application Priority Data
Sep. 6, 2002 (JP) 2002-261083

(51) Int. Cl. G06F 15/00; G06K 1/00

(52) U.S. Cl. 358/1.1; 358/1.15

(57) ABSTRACT

Multiple ports that receive print jobs are logically set in a printing apparatus, and attributes used for specifying printing settings are assigned to at least one of these multiple ports. When a print job is received, the printing apparatus refers to attributes of the port that received the print job, and processes the print job based on these attributes. As a result, a printing apparatus is provided in which the burden of configuring various settings pertaining to print jobs, such as the printer settings that govern the printer driver, is reduced.

### CROSS-REFERENCE TO RELATED APPLICATIONS

This application is based on application No. 2002-261083 filed in Japan, the contents of which is hereby incorporated by reference.

### BACKGROUND OF THE INVENTION

1. Field of the Invention

The present invention relates to a printing apparatus that prints data received over a network or the like, and more particularly to a printing apparatus in which various printing settings may be made when a print request is issued.

2. Description of the Related Art

In general, when printing document data created on a personal computer (PC), the user can configure in the printer driver, which constitutes software that generates print jobs suited to the printer, settings regarding the paper size and the print finish such as the print quality (printer settings). As printers have acquired more functions in recent years, printer drivers have been able to handle a large number of settings, thereby increasing user convenience.

At the same time, as the number and types of settings that can be made in printer drivers have increased and the setting screens have accordingly become more complex, it can be extremely difficult for users to carry out such a setting operation, which can be rather complicated and difficult.

There are a limited number of combinations of settings that are frequently used by users, and it is troublesome for a user to have to frequently enter the same settings each time a print job is executed.

### OBJECTS AND SUMMARY

An object of this invention is to provide a printing apparatus that reduces the burden on the user of entering various printer settings when issuing a print command.

In the printing apparatus according to the present invention, multiple ports that receive print jobs are logically assigned. Attributes for specifying print settings are assigned to at least one of these multiple ports. When a print job is received, the printing apparatus refers to the attributes of the port that received the print job, and processes the print job based on the print settings specified for those attributes.

In other words, according to this printing apparatus, prescribed attributes are assigned to a virtual printer port, and the print job allocated to that printer port is processed based on the attributes for that printer port. As a result, the tasks required for making various settings in connection with a print job, such as user-entered printer settings to govern the printer driver, are eliminated.

The control method according to the present invention is a method for controlling a printing apparatus, wherein multiple ports that receive print jobs are logically set, attributes for specifying print settings are assigned to at least one of these multiple ports, and when a print job is received, the printing apparatus refers to the attributes of the port that received the print job, and processes the print job based on the print settings specified for those attributes.

In other words, by using the above method, the tasks required for making various settings in connection with a print job, such as user-entered printer settings to govern the printer driver, are eliminated.

These and other objects, advantages and features of the invention will become apparent from the following description thereof taken in conjunction with the accompanying drawings which illustrate specific embodiments of the invention.

### BRIEF DESCRIPTION OF THE DRAWINGS

FIG. 1 is a drawing showing the construction of a printer pertaining to the present invention;

FIG. 2 is a drawing that describes processing carried out by a printer controller with reference to port attributes;

FIG. 3 is a drawing that describes an implementation of the functions of a printer controller within a Windows® application;

FIG. 4 is a schematic drawing that describes the processing executed by the printer controller where port attributes are assigned to each of two virtual ports;

FIG. 5 is a drawing that describes an example of port attributes that enable selection of two types of print engine having different functions;

FIG. 6 is a drawing that describes the processing executed by the printer controller where port attributes are assigned to each of three virtual ports;

FIG. 7 is a drawing that shows the print results after processing is executed in accordance with the port attributes;

FIG. 8 is a drawing showing a construction that enables authorization processing; and

FIG. 9 is a drawing showing a construction that enables fee-based processing.

In the following description, like parts are designated by like reference numbers throughout the several drawings.

### DESCRIPTION OF THE PREFERRED EMBODIMENTS

Embodiments of the printer pertaining the present invention will be described in detail below with reference to the attached drawings.

(Embodiment 1)

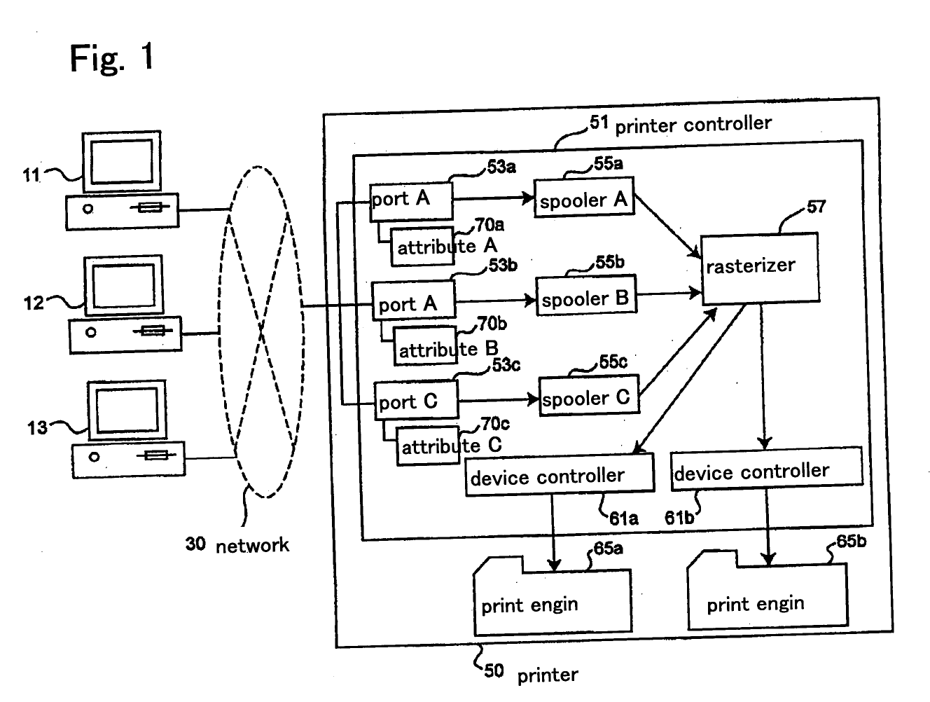

FIG. 1 shows the construction of a printer pertaining to the present invention. The printer 50 includes a printer controller 51 that controls printing and print engines 65a and 65b that print images on paper and execute prescribed processing. The print engines 65a and 65b have different printing-related functions. Here, a print engine is a unit actually prints images onto printing paper and executes processing such as the punching of punch holes in the paper after printing. The print engines do not have the function of generating image data from PDL (Page Description Language).

The printer 50 receives print jobs from information processing terminals 11, 12, . . . over a network 30 such as a LAN and prints them.

The printer controller 51 includes three virtual printer ports 53a-53c that are logically assigned, spoolers 55a-55c that exist for each of these ports, a rasterizer 57, and device controllers 61a and 61b. The printer controller 51 has the function of controlling print processing for the printer 50, and the functions of the printer controller 51 can be implemented by a hardware resource such as a CPU and a program working together.

The rasterizer 57 is a module that implements a rasterizing function by which letter or image data is developed into raster data.

The device controllers 61a and 61b are disposed in the print engines 65a and 65b, respectively, and constitute modules that control the respective print engines 65a and 65b.

Port A (53a), port B (53b) and port C (53c) each constitute a logical port, rather than a physical port. Attributes 70a-70c that specify various settings are allocated to the ports 53a-53c, respectively. The attributes assigned to the three ports include such attributes as an RIP attribute for configuring the printer settings, a Finish attribute, and a connected device name attribute.

The RIP attribute is an attribute that specifies the status regarding the imaged image. The RIP attribute is an attribute used for specifying the page attribute settings used for configuring the image printing method, such as magazine-type folded printing, printing of multiple page images to a single sheet of paper (hereinbelow, the setting for printing (N) pages of images to a single sheet of paper is deemed ‘N-Up’), the resolution, monochrome/color printing, etc.

The Finish attribute is an attribute that specifies the finish settings used for configuring the physical processing (finish processing) to be performed to the paper after the printing of images thereon, such as Z-configuration folding, hole punching and stapling.

The connected device name is an attribute used for specifying the device name of the print engine used when images are actually printed.

The basics of the operation of the printer having the above construction are described below.

The user specifies the printer port to which the print job is to be sent from the information processing terminal 11, and issues a print command. The printer 50 receives the print job sent from the information processing terminal 11 at the specified port 53a, 53b or 53c via the network 30, and spools the print job to the spooler 55a, 55b or 55c corresponding to the receiving port 53a, 53b or 53c. The spooled print job is then forwarded to the rasterizer 57. The rasterizer 57 rasterizes the print job, generates page images, and issues a print request to the device controllers 61a and 61b. The device controllers 61a and 61b control the print engines 65a and 65b, respectively, and print the page images. During this processing, the rasterizer 57 and the device controllers 61a and 61b each perform rasterizing and control the print engines in accordance with the port attributes 70a, 70b or 70c to which the print job was sent.

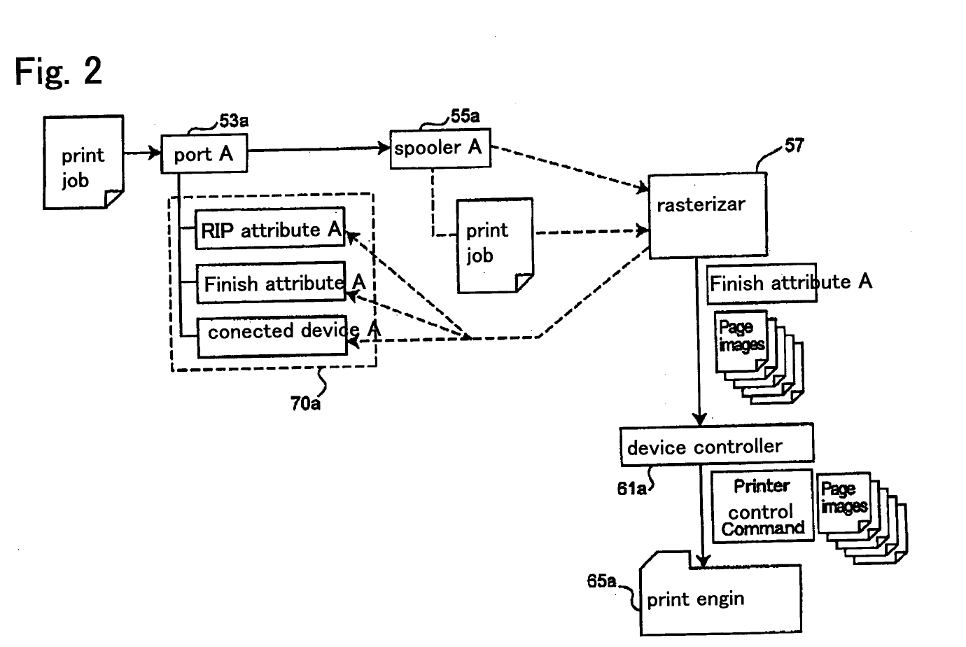

The handling of the port attributes 70a, 70b or 70c will now be described in detail with reference to FIG. 2.

When the user sends a print job from the information processing terminal 11, the port to which the print job is to be output is specified. In a Windows® application, for example, this specification can be made using the printer driver properties. Here, as shown in FIG. 2, it is assumed that the print job is sent to the port A (53a). The attributes 70a are assigned to the port A (53a). The attributes 70a include the RIP attribute A, the Finish attribute A and the connected device name A. When the print job is sent to the port A, the print job is spooled to the spooler A (55a) corresponding to that port A (53a). The rasterizer 57 obtains the attributes 70a for the port A, rasterize the print job with reference to the attributes 70a, and generate page images. The rasterizer 57 then adds the Finish attribute A from among the obtained attributes and issues a print request to the device controller 61a to print the page images. The device controller 61a controls the print engine 65a and prints the page images.

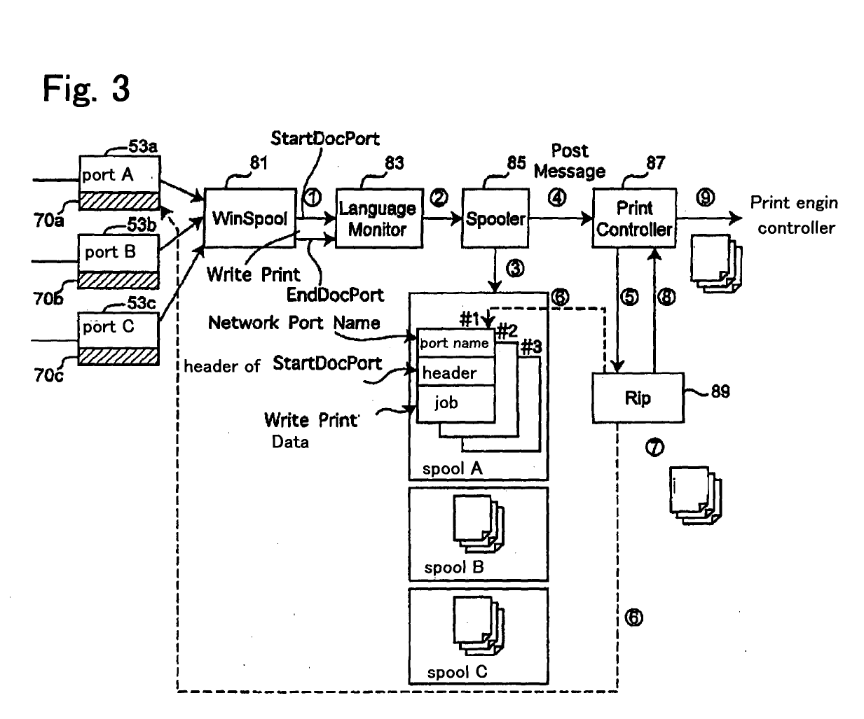

FIG. 3 is a drawing that describes the processing of a print job from within a Windows® application with reference to the port attributes.

In FIG. 3, WinSpool (81), Language Monitor (83), Spooler (85), Print Controller (87) and Rip (89) are function modules or module groups that are configured based on Windows® standards.

The functions of the rasterizer 57 shown in FIG. 1 and other drawings are implemented via Rip (89) and Print Controller (87), while the functions of the spoolers 55a-55c are implemented via WinSpool (81), Language Monitor (83) and Spooler (85).

As shown in FIG. 3, the attributes 70a, 70b and 70c that specify printer settings are assigned to the ports A (53a), B (53b) and C (53c), respectively. The sequence of processes executed when a print job is output to the port A (53a) will be described below.

\mathring{1} WinSpool (81) issues to the port a request to output the print job to Language Monitor (83).

\mathring{2} Language Monitor (83) requests that the print job be queued to Spooler (85) rather than to the LPT port.

\mathring{3} Spooler (85) queues the header information output by WinSpool (81) (including the print job transmission time, the recipient and other information), the network port name managed by Winspool and the actual data. When this is done, an index (#1, #2, . . . ) is added and queued. In addition, Spooler (85) manages the print jobs queued at each port.

\mathring{4} Spooler (85) specifies an index to Print Controller (87) each time a print job is queued and issues a post message.

\mathring{5} Print Controller (87) specifies an index to Rip (89) and issues a printing instruction.

\mathring{6} Rip (89) identifies the port to which the print job was output with reference to the port name (network port name) information added to the queued print job, and generates, with reference to the attributes 70a of the identified port, the print job image forming method defined for that port and printing parameters for specifying Finish processes such as hole punching and stapling.

\mathring{7} Rip (89) generates a rasterized image based on the image forming method for the print job obtained in step \mathring{6} above.

\mathring{8} Rip (89) notifies Print Controller (87) of the results of steps \mathring{7} and \mathring{6.}

\mathring{9} Print Controller (87) controls the print engine in accordance with the printing parameters generated in step \mathring{6} and causes the printer to print the images generated in step \mathring{7} the generated images.

Examples of port attributes will now be described below.

### EXAMPLE 1

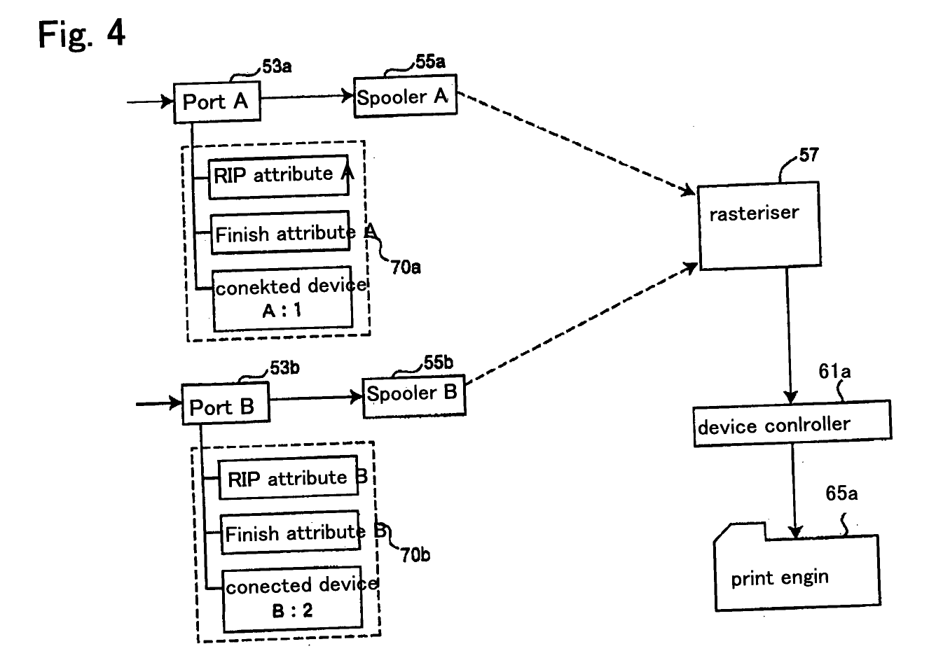

A situation in which the RIP attribute and the Finish attribute are set specifically as follows in the two logical (virtual) printer ports (port A, port B) shown in FIG. 4 will be described below.

TABLE 1

| | Port A | Port B |
|---|---|---|
| RIP attribute | 2-UP | 1-UP |
| Finish attribute | No hole punching | Punch two holes |

If a print job is sent to the port A (53a), two pages of images are printed (2-Up processing) on one sheet of paper with reference to the attributes 70a for that port, and no holes are punched. If a print job is sent to port B (53b), one page of images is printed on one sheet of paper (1-Up processing) with reference to the attributes 70b for that port, and two punch holes are formed in the printing paper.

### EXAMPLE 2

A situation in which the RIP attribute and the Finish attribute are set as described below will now be described. In the table below, the value ‘1’ corresponding to ‘Connected device name’ indicates that the print engine 65a operates as the output device, while a ‘2’ indicates the print engine 65b. The print engine 65a has a resolution of 1200 dpi and is capable of color printing. Conversely, the print engine 65b has a resolution of 600 dpi and is capable only of monochrome printing.

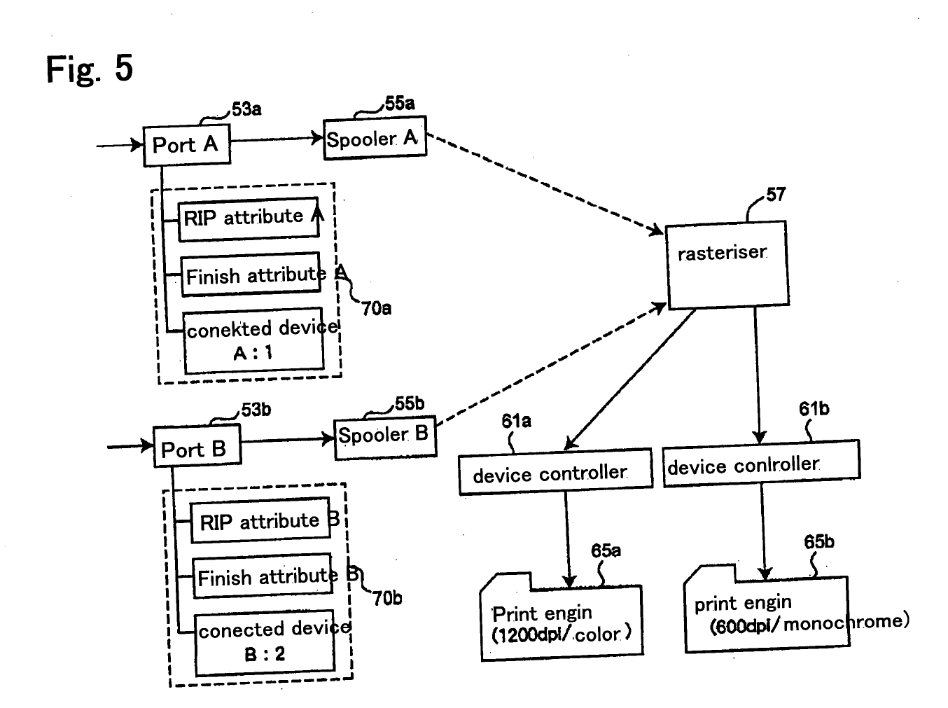

TABLE 2

| | Port A | Port B |
|---|---|---|
| RIP attribute | 1200 dpi | 600 dpi |
| | Color | Monochrome |
| Connected device name | 1 | 2 |

Where the port attributes are set as described above, if a print job is sent to port A as shown in FIG. 5, the print engine 65a is selected and color printing is carried out at a resolution of 1200 dpi. If a print job is sent to port B, the print engine 65b is selected and monochrome printing is carried out at a resolution of 600 dpi.

### EXAMPLE 3

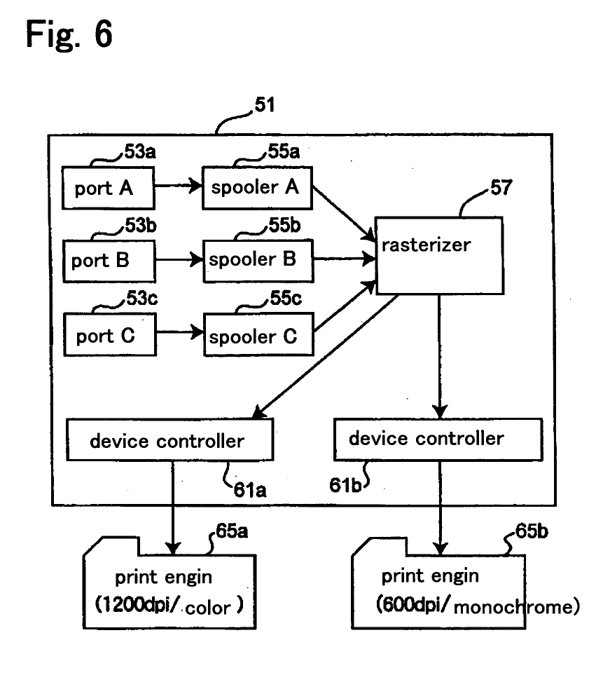

A situation in which the three virtual ports of port A, port B and port C are assigned as shown in FIG. 6 and the attributes corresponding to each port are as shown below will now be explained.

TABLE 3

| | Port A | Port B | Port C |
|---|---|---|---|
| RIP attribute | 2-UP | 1-UP | 2-UP |
| | 1200 dpi | 600 dpi | 600 dpi |
| | Color | Monochrome | Monochrome |
| Connected device | 1 | 2 | 2 |
| name | | | |
| Finish attribute | No hole punching | Punch two | No hole punching |
| | | holes | |

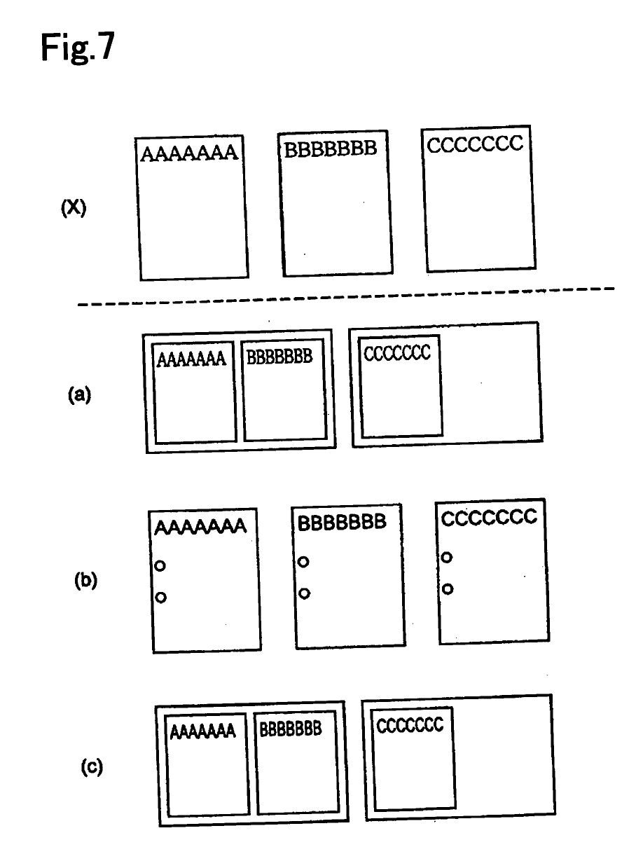

If the print job shown in row (X) in FIG. 7 is sent to port A, it undergoes 2-Up color printing at a resolution of 1200 dpi by the print engine 65a and no punch holes are formed, as shown in FIG. 7(a). If the print job is sent to port B, it undergoes 1-Up monochrome printing at a resolution of 600 dpi by the print engine 65b and two punch holes are formed, as shown in FIG. 7(b). If the print job is sent to port C, it undergoes 2-Up monochrome printing at a resolution of 600 dpi by the print engine 65b and no punch holes are formed, as shown in FIG. 7(c).

As described above, in this embodiment, attributes associated with printer settings are set for virtual printer ports. Where printer setting attributes are assigned to virtual printer ports in this fashion, printer setting is automatically carried out when a printer port is set. Consequently, when the user assigns a print job to a printer, there is no need for the user to change the printer settings in the printer driver, relieving the user of the obligation to perform complex tasks in order to ensure that printing is performed.

(Embodiment 2)

In this embodiment, a construction that enables user authorization for each printer port will be described. In this printing apparatus, user authorization information is included in the printer port attributes.

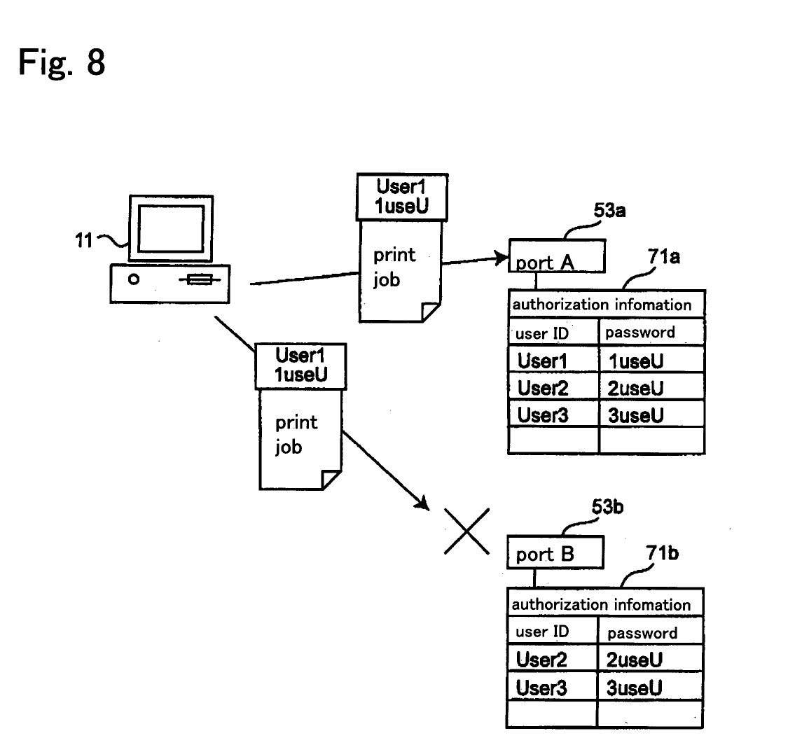

An example of this construction is shown in FIG. 8. In the example shown in FIG. 8, the authorization information 71a is set for the port A (53a), and the authorization information 71b is set for the port B (53b). The authorization information includes a user ID and password, for example.

The user ID and password are contained in the header for the print job transmitted from the information processing terminal 11. If the user ID and password contained in the print job header match the user ID and password contained in the authorization information in the attributes for the port to which the print job was sent (i.e., if authorization is granted), the printer controller 51 forwards the print job to the spooler and performs print processing. If they do not match, the received print job is discarded and print processing is not performed. In the case shown in FIG. 8, the authorization information 71a for the port A includes authorization information for a user having a user ID of ‘User1’ and a password of ‘1useU’ (hereinafter referred to as ‘User 1’), while authorization information for User 1 is not included in the authorization information 71b for port B. Therefore, while User 1's print job undergoes print processing by port A, it is discarded and not processed by port B.

User authorization is enabled by setting the authorization information as a printer port attribute as described above.

(Embodiment 3)

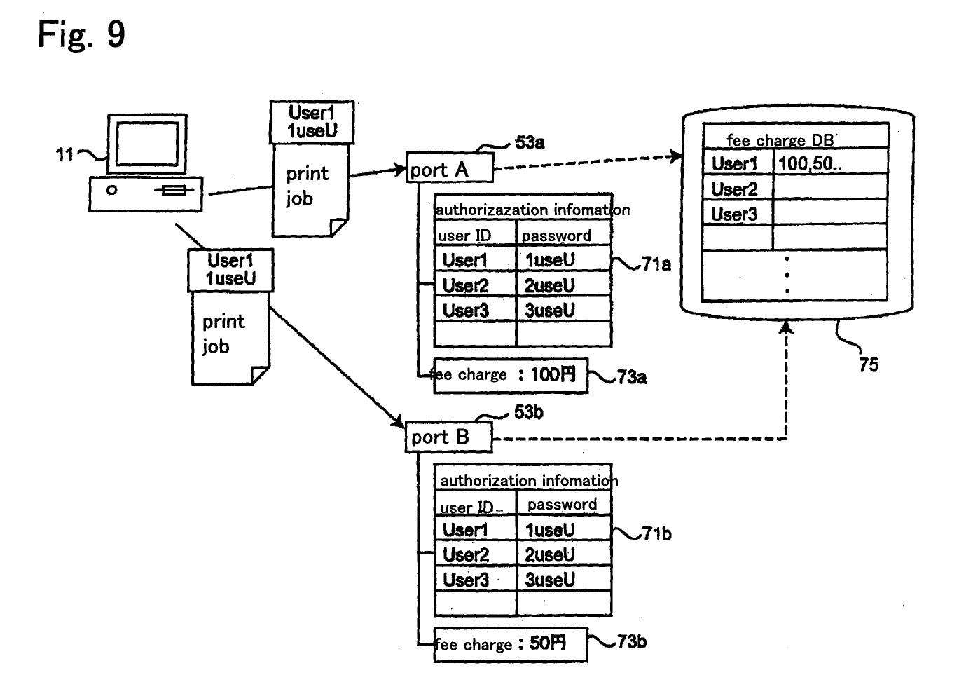

In this embodiment, a construction that enables a fee to be charged for each printer port will be described. An example of this construction is shown in FIG. 9.

In this embodiment, fee charging information 73a and 73b is set in the printer ports, respectively, in addition to the authorization information 71a and 71b described above. Here, the fee charging information 73a or 73b is used for charging a fee for one use of the associated printer port. Furthermore, a fee charging database 75 is also present. The fee charging database 75 is updated for each user when a port is used, based on the fee charging information 73a or 73b.

In other words, each time a print job is sent to a printer port, first, the printer controller 57 refers to the authorization information 71a or 71b among the attributes for that port and performs user authorization, whereupon charge amount data determined from the fee charging information 73a or 73b for that port is added to the record for that user in the fee charging database 75. For example, where port A is used, ‘100’ is added to the user record, while ‘50’ is added to the user record if port B is used.

Fee charging for execution of a user's print request is enabled by setting the fee charging information as a printer port attribute as described above.

By assigning prescribed attributes to virtual printer ports and executing processing of a print job sent to such printer ports based on the port attributes as described above, the burden of carrying out various setting tasks in connection with the print job can be reduced. For example, the burden on the user of entering printer settings in a printer driver can be minimized. Furthermore, processing for an individual port (authorization processing, fee charging processing, etc.) can be easily enabled. Moreover, the configuration and management of processing for each port can be easily carried out by the system administrator.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. A printing apparatus comprising:
a multiple ports that receive print jobs are logically set, and attributes used for specifying printing settings are assigned to at least one of said multiple ports; and
a controller that, when a print job is received, processes said print job based on the printing settings specified in the attributes while referring to the port that received the print job.

2. The printing apparatus according to claim 1, wherein the attributes for at least one of said ports include user authorization information.

3. The printing apparatus according to claim 1, wherein the attributes for at least one of said ports include fee charging information indicating the fee to be charged for the use of each port.

4. The printing apparatus according to claim 1, wherein said printing settings include finishing settings relating to such tasks as stapling and hole punching.

5. The printing apparatus according to claim 1, wherein said printing settings include settings relating to color and monochrome printing.

6. The printing apparatus according to claim 1, wherein said printing settings include RIP settings such as 1-UP and 2-UP settings.

7. A program product that controls a printing apparatus, wherein multiple ports that receive print jobs are logically set and attributes used for specifying printing settings are assigned to at least one of said multiple ports, and wherein said printing apparatus is controlled such that when a print job is received, said print job is processed based on the printing settings specified in the attributes while referring to the port that received the print job.

8. The program product according to claim 7, wherein the printing apparatus is controlled such that user authorization information is assigned as an attribute associated with at least one of said multiple ports.

9. The program product according to claim 7, wherein fee charging information that indicates a fee charged for use of a port is assigned as an attribute associated with at least one of said multiple ports.

10. A control method for controlling a printing apparatus, said method comprising:
logically setting multiple ports that receive print jobs,
assigning attributes used for specifying the printing settings to at least one of said multiple ports; and
processing a received print job based on the printing settings specified for the attributes of the port that received the print job while referring to the attributes for said port.

11. The control method according to claim 10, wherein the print resolution setting is included in the attributes for specifying said printing settings.
